(19) United States
(12) Patent Application Publication
(10) Pub. No.: US 2009/0130966 A1
(43) Pub. Date: May 21, 2009

(54) VEHICLE CABIN VENTING ARRANGEMENT

(76) Inventor: David Wayne Tucker, Waterford, MI (US)

Correspondence Address: CARLSON, GASKEY & OLDS, P.C., 400 WEST MAPLE ROAD, SUITE 350, BIRMINGHAM, MI, 48009, US

(21) Appl. No.: 12/271,967

(22) Filed: Nov. 17, 2008

Related U.S. Application Data
(60) Provisional application No. 61/003,466, filed on Nov. 16, 2007.

(51) Int. Cl. B60H 1/24

(52) U.S. Cl. 454/75; 236/49.3; 454/128; 454/129

(57) ABSTRACT

An example vehicle cabin temperature control arrangement includes a sensor and a controller module operatively connected to the sensor. An actuator is operatively connected to the controller, which is configured to initiate the actuator to move a component to vent a vehicle cabin in response to a signal from the sensor.

### CROSS-REFERENCE TO RELATED APPLICATIONS

This application claims priority to U.S. Provisional Application No. 61/003,466, which was filed on 16 Nov. 2007 and is incorporated herein by reference.

### BACKGROUND

This application relates generally to controlling temperature within a vehicle cabin.

As known, exposing a vehicle to high temperatures heats the vehicle cabin. Under some conditions, the temperature in the vehicle cabins can rise to greater than 150° F. That is, the temperature inside the vehicle cabin can far exceed the temperature outside the vehicle cabin. High temperatures in the vehicle cabin can disadvantageously deteriorate the vehicle. For example, the heat can melt or deform components within the vehicle cabin, such as dashboards, seats, and other component surfaces. Higher temperatures deteriorate the components within the vehicle cabin faster than lower temperatures.

The heated vehicle cabin is also an uninviting environment for potential vehicle occupants. For example, the surfaces of components within the vehicle cabin can retain heat making the component painful to touch. Once inside the vehicle, the occupants' heads are typically positioned within the upper areas of the vehicle cabin, which, because heat in the vehicle cabin rises, are usually the hottest areas of the vehicle cabin. The occupants thus breathe the hottest air within hot vehicle cabin. Many vehicle occupants attempt to reduce the temperature of the vehicle cabin soon after they enter the vehicle, such as by rolling down windows, turning on the air conditioner system, etc. Higher temperatures take longer to reduce to a comfortable level than lower temperatures.

### SUMMARY

An example vehicle cabin temperature control arrangement includes a sensor and a controller module operatively connected to the sensor. An actuator is operatively connected to the controller, which is configured to initiate the actuator to move a component to vent a vehicle cabin in response to a signal from the sensor.

An example vehicle cabin temperature control arrangement includes a controller module that is operative to receive an input from a sensor and configured to initiate venting a vehicle cabin in response to the input.

An example method of controlling airflow from a vehicle cabin includes sensing a condition and facilitating airflow from a vehicle cabin in response to the sensed condition.

These and other features of the disclosed examples can be best understood from the following specification and drawings. The following is a brief description of the drawings.

### BRIEF DESCRIPTION OF THE DRAWINGS

FIG. 1 shows a high-level schematic view of an example arrangement for controlling a vehicle cabin temperature.

FIG. 2 shows a perspective view of an example vehicle incorporating the FIG. 1 arrangement.

FIG. 3 shows an example method of controlling the vehicle cabin temperature of the FIG. 2 vehicle.

### DETAILED DESCRIPTION

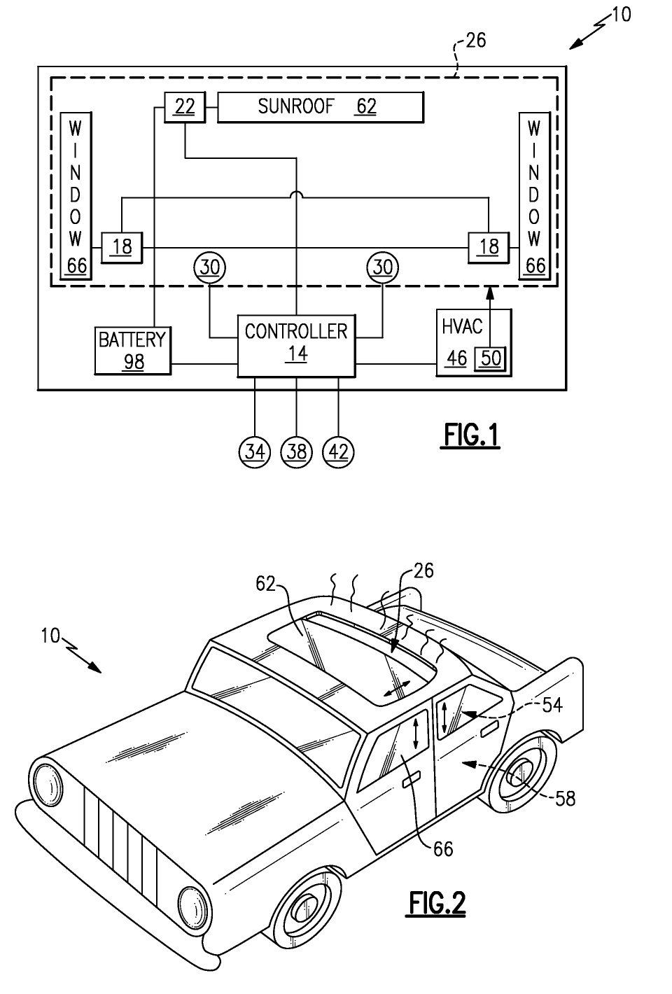

Referring to FIG. 1, an example vehicle 10 includes a controller 14 operatively linked to a plurality of window actuators 18 and a sunroof actuator 22. In this example, the controller 14 is located outside of a vehicle cabin 26. In another example, the controller 14 is located inside of the vehicle cabin 26.

In response to commands from the controller 14, the window actuators 18 each actuate a window 66 between positions that permit more or less airflow between the vehicle cabin 26 and the surrounding environment. The sunroof actuator 22 actuates a moveable portion of a sunroof 62 between positions that permit more or less airflow between the vehicle cabin 26 and the surrounding environment.

In this example, a plurality of interior temperature sensors 30 provide information to the controller 14 relating to the temperatures inside the vehicle cabin 26. Using the plurality of interior temperature sensors 30 allows the controller 14 to receive temperature information from different areas of the vehicle cabin 26. Other examples may utilize only one of the interior temperature sensors 30.

An exterior temperature sensor 34 provides information to the controller 14 about the temperature outside the vehicle cabin 26. A humidity sensor 38 and a rain sensor 42 also provide information to the controller 14 about humidity conditions and rain conditions outside the vehicle cabin 26 respectively. To provide information, the interior temperature sensors 30, the exterior temperature sensor 34, the humidity sensor 38, and the rain sensor 42 transmit signals to the controller 14 in a known manner. Such sensors are known in the art.

The controller 14 initiates the window actuators 18, the sunroof actuator 22 or both based on the information received from the interior temperature sensors 30, the exterior temperature sensor 34, the humidity sensor 38, the rain sensor 42, or some combination thereof. In one example, the controller 14 initiates the sunroof actuator 22 to open the sunroof 62 in response to a difference between the temperature detected by the plurality of interior temperature sensors 30 and the temperature detected by the exterior temperature sensor 34 of more than 20° F. In this example, the controller 14 also initiates the sunroof actuator 22 to close the sunroof 62 in response to the humidity sensor 38 detecting a particular humidity level or the rain sensor 42 detecting rain.

The example vehicle 10 also includes an HVAC system 46 linked to the controller 14. The example controller 14 is a type of control module and may control other component within the vehicle 10, such as an HVAC system 46.

In one example, the controller 14 initiates a fan 50 within the HVAC system of the vehicle 10 to move air in response to a difference between the temperature detected by the plurality of interior temperature sensors 30 and the temperature detected by the exterior temperature sensor 34 of more than 20° F. The example fan 50 is configured to move air to the vehicle cabin 26, which, when the sunroof 62 or the windows 66 are open, facilitates circulating air through the vehicle cabin 26.

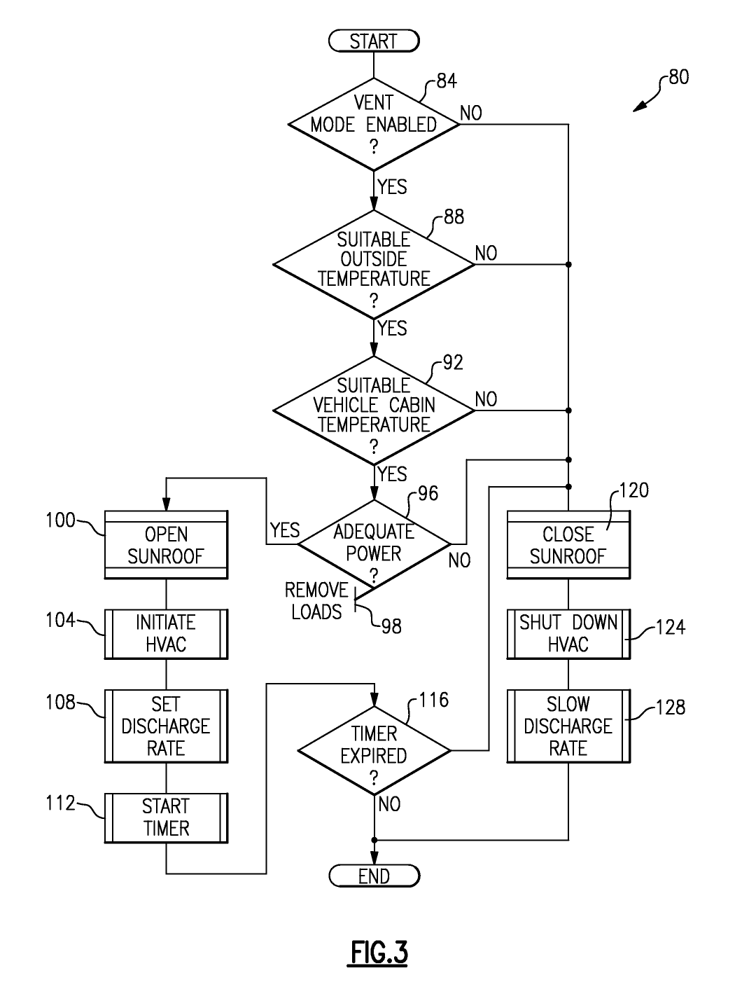

Referring now to FIG. 2 with continuing reference to FIG. 1, the vehicle cabin 26 generally includes an upper cabin area 54 and a lower cabin area 58. The upper cabin area 54 corresponds generally to the areas of the vehicle cabin 26 that are vertically closest to the sunroof 62. The lower cabin area 58 corresponds generally to the areas of the vehicle cabin 26 that are vertically furthest from the sunroof 62. As known, heat build up in the vehicle cabin 26 rises within the vehicle cabin 26 and concentrates in the upper cabin area 54. That is, the temperature of the vehicle cabin 26 decreases moving vertically away from the sunroof 62.

Opening the sunroof 62 facilitates movement of thermal energy from the vehicle cabin 26, and particularly the upper cabin area 54. Opening the sunroof 62 facilitate moving the hottest air from the vehicle cabin 26 first. In some examples, the windows 66 also open in response to a command by the controller 14.

Referring now to FIG. 3 with continuing reference to FIG. 1, an example method 80 of controlling airflow from a vehicle cabin includes the step of determining whether or not the user has enabled the cabin vent mode at step 84. In one example, a driver information center 70 within the vehicle cabin 26 includes a programmable option enabling the user to select or deselect the user enabled cabin vent mode at step 84. In this example, the vehicle cabin 26 is unoccupied, however, the user has enabled, or disabled, the cabin vent mode at step 84 prior to exiting the vehicle 10. Driver information centers are known, and a person skilled in the art and having the benefit of this disclosure would be able to incorporate such a selection option into such a center.

At step 88 the example method 80 determines whether or not the outside temperature sensed by exterior temperature sensor 34 is within a range suitable for initiating the sunroof actuator 22 to vent the vehicle cabin 26. In one example, detecting a temperature outside the vehicle cabin 26 of between 70° F. and 90° F. is considered suitable for venting the vehicle cabin 26.

If the outside temperature sensed by the exterior temperature sensor 34 is suitable for venting the vehicle cabin 26, the method 80 next moves to step 92 where the controller 14 determines whether or not the temperature inside the vehicle cabin 26 sensed by the plurality of interior temperature sensors 30 is suitable for venting the vehicle cabin 26. In one example, detecting a temperature inside the vehicle cabin 26 that is at least 20° F. more than the outside temperature detected in step 88 is considered suitable for venting the vehicle cabin 26.

If the temperature sensed by the plurality of interior temperature sensors 30 is suitable for venting the vehicle cabin 26, the method 80 next moves to step 96 where the controller 14 determines if there is adequate power within the vehicle 10 to support venting the vehicle cabin 26. A vehicle battery 98 provides power in one example. In one example, the method 80 checks the vehicle battery 98 to determine if the vehicle battery 98 has sufficient power to support actuating the sunroof 62. As known, the sunroof actuator 22, the controller 14, or both may require power. At step 98, the method 80 may remove loads from the battery to free power.

If the vehicle battery 98 has sufficient power, the method 80 next moves to step 100 where the controller 14 initiates the sunroof actuator 22 to open the sunroof 62. The air within the vehicle cabin 26, especially the hottest air in the vehicle cabin 26 near the sunroof 62, is then free to move through the open area of the sunroof 62 to the exterior of the vehicle 10. In this example, the sunroof actuator 22 opens the sunroof 62 approximately 2 inches. Detecting a higher temperature within the range may cause the controller 14 to initiate the sunroof 62 to also open different amounts, or to initiate the windows 66 to open. In vehicles that lack a sunroof 62, the windows 66 may be the only component capable of venting the vehicle cabin 26. A person having ordinary skill in this art and having the benefit of this disclosure would be able to configure the controller 14 to facilitate maximum cooling of the vehicle cabin 26.

In this example, the method 80 next initiates the HVAC system 46 at step 104 to power the fan 50, which moves air into the vehicle cabin 26 near the lower cabin area 58. The example method powers only the fan 50, not other fans (not shown) configured to move air to other areas of the vehicle cabin 26. Powering the fan 50 moves air into the lower cabin area 58, which facilitates circulating air through the vehicle cabin 26 and through the sunroof 62.

At step 108, the method 80 sets the discharge rate for the fan 50 to high to maximize air movement into the lower cabin area 58. In another example, the discharge location of the fan 50 can be calibrated. That is, the user can configure the method 80 to position the fan 50 such that the fan 50 moves air in a particular direction within the vehicle cabin 26.

The method 80 starts a timer at step 112. In one example, the timer counts down from 10 minutes. At step 116, the method 80 determines whether or not the timer from step 112 has expired. If expired, the method 80 moves to step 120, and the controller 14 initiates the sunroof actuator 22 to close the sunroof 62. The method 80 then shuts down the fan 50 at step 124 and the discharge rate of the fan 50 at step 128.

In another example, the method 80 monitors temperature inside the vehicle cabin 26 using the interior temperature sensors 30 and then closes the sunroof 62 to inhibit venting the vehicle cabin 26 after the measured temperature reaches a desired level. In some examples, the method 80 reduces the opening size of the sunroof 62, rather than entirely closing the sunroof 62, to inhibit venting after the measured temperature reaches a desired level. A higher measured temperature causes controller 14 to initiate a larger opening size than a lower temperature, for example.

In yet another example, the method 80 monitors humidity levels outside the vehicle 10 using the humidity sensor 38 and rainfall using the rain sensor 42. The method closes the sunroof 62 after the humidity reaches a particular level or after rainfall is detected.

Features of the disclosed embodiment include cooling a vehicle cabin by facilitating air movement from the vehicle cabin and particularly the upper portion of the vehicle cabin.

Although a preferred embodiment has been disclosed, a worker of ordinary skill in this art would recognize that certain modifications would come within the scope of this invention. For that reason, the following claims should be studied to determine the true scope and content of this invention. We claim:

1. A vehicle cabin temperature control arrangement, comprising:
a sensor;
a controller module operatively connected to the sensor; and
an actuator operatively connected to the controller, wherein the controller is configured to initiate the actuator to move a component to vent a vehicle cabin in response to a signal from the sensor.

2. The arrangement of claim 1, wherein the sensor comprises a temperature sensor.

3. The arrangement of claim 1, wherein the sensor is configured to monitor a temperature of air within the vehicle cabin.

4. The arrangement of claim 3, wherein the sensor is configured to monitor a temperature of air within an upper portion of the vehicle cabin.

5. The arrangement of claim 1, wherein the sensor comprises a moisture sensor.

6. The arrangement of claim 1, further including a fan, wherein the controller is configured to initiate the fan to move air within the vehicle cabin.

7. The arrangement of claim 6, wherein the fan moves air to a lower portion of the vehicle cabin.

8. The arrangement of claim 1, wherein the actuator comprises a body control module.

9. The arrangement of claim 1, wherein the component comprises a sunroof.

10. The arrangement of claim 1, wherein the component comprises a window.

11. The arrangement of claim 1, wherein the vehicle cabin comprises an unoccupied vehicle cabin.

12. A vehicle cabin temperature control arrangement, comprising:
a controller module operative to receive an input from a sensor and configured to initiate venting a vehicle cabin in response to the input.

13. The arrangement of claim 12, wherein the controller module comprises an HVAC fan.

14. The arrangement of claim 12, wherein the controller module is operative to receive a second input from the sensor, different from the first input, and configured to inhibit venting the vehicle cabin in response to the second input.

15. A method of controlling airflow from a vehicle cabin, comprising:
(a) sensing a condition; and
(b) facilitating airflow from a vehicle cabin in response to the sensed condition.

16. The method of claim 15, wherein said step (b) comprises moving at least one of a vehicle sunroof or a vehicle window to create an opening for airflow.

17. The method of claim 16, including varying size of the opening based on the sensed condition.

18. The method of claim 15, wherein said step (b) comprises facilitating airflow from an upper portion of the vehicle cabin.

19. The method of claim 15, including the steps of sensing a second, different condition and inhibiting airflow from the cabin in response to the second condition.

20. The method of claim 15, wherein the vehicle cabin comprises an unoccupied vehicle cabin.
